(19) United States
(12) Patent Application Publication
(10) Pub. No.: US 2010/0094712 A1
(43) Pub. Date: Apr. 15, 2010

(54) INTERNAL ADVERTISING SPACE ALLOCATION

(75) Inventor: Aaron Lai, Alameda, CA (US)

Correspondence Address: Weiss & Arons, LLP, 1540 Route 202, Suite 8, Pomona, NY, 10970, US

(73) Assignee: Bank of America Corp., Charlotte, NC (US)

(21) Appl. No.: 12/248,980

(22) Filed: Oct. 10, 2008

(51) Int. Cl. G06Q 30/00

(52) U.S. Cl. 705/14.68

(57) ABSTRACT

Apparatus and methods for market-based allocation of internal web advertising space. Internal web advertising typically involves a company website hosting advertisements for company lines of business. Market-based bids for advertising space may be adjusted by an advertisement servicing program for overall site optimization. In some embodiments, bidding power for some lines of business may be adjusted as a reward for successful advertising, or based on other business criteria.

### FIELD OF TECHNOLOGY

Aspects of the invention relate to the allocation of website-based internal advertising space.

### BACKGROUND

Internet advertising is the marketing of products or services over the Internet. The Internet offers unique advantages over other forms of marketing: low costs for distribution, a global audience, potential for instant response, and the ability to target advertising to likely customers.

An important subset of Internet marketing is website-based advertising placements (“web advertising”). Advertisers may compete for space on a website just as they do for airtime or space in print media.

Web advertising may be managed by an advertisement servicing system. A typical advertisement servicing system may adjust the advertisement display and pricing based on customer behavior. A servicing system tailored to a website owner seeks to maximize overall profit, but does not consider the fortunes of each individual advertiser.

A special case of web advertising arises when a company website advertises its own lines of business, a case known as internal advertising. In internal advertising, the company seeks to maximize profit, but also to make its advertisers successful. A servicing system for internal advertising should take into account the priorities of both groups.

To address the advertisers' needs, a system should protect the competitiveness of different lines of business. A market-based system allows each line of business to maintain its own advertising strategy.

To address the company's needs, a system should allow for allocation of website space based on larger company objectives. A company may want to weight the allocation based on the effectiveness of an advertising campaign or on other business strategy criteria.

It would be desirable therefore, to manage internal web advertising with an advertisement servicing system able to preserve free competition for the advertisers and at the same time address the company concern for flexibility and overall productivity.

### SUMMARY OF THE INVENTION

It is an object of this invention to provide apparatus and methods for market-based internal web advertising space allocation. Apparatus and methods for allocating company web advertising space among internal advertisers are therefore provided. The apparatus and methods may involve granting a predetermined number of tokens to company divisions to spend on internal advertising. The advertisers may use the tokens to bid for exposure on the company website. A servicing system may proportionately adjust the bids based on the total space available. After an adjustment, each advertiser may approve its adjusted bid or submit a revised bid. After the final adjustment, any excess tokens may be refunded to the advertisers. In some embodiments, successful advertising may be rewarded with a greater number of tokens for future bidding.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 is a schematic diagram of apparatus that may be used in accordance with the principles of the invention;

FIG. 2 is a flow diagram that shows a process in accordance with the principles of the invention;

FIG. 3 is a flow diagram that shows a process that corresponds to a portion of the process shown in FIG. 2; and

FIG. 4 is a table that shows a numerical illustrative example that corresponds to a portion of the process shown in FIG. 2.

### DETAILED DESCRIPTION OF THE INVENTION

Apparatus and methods for a market-based internal web advertising space allocation system are provided. Internal advertising is a case where one or more divisions of a larger entity advertise in entity owned space. Internal web advertising typically involves a company-run website hosting advertisements for one or more lines of business (“advertisers”). In a market-based allocation system, advertisers may compete for advertising space on the website. Advertising space may include advertisement placement, display frequency or any other allocable means of web advertising (“advertising space”).

The invention may apply apparatus and methods to adjust bids to avoid waste while still giving weight to advertiser intent. Each advertiser may bid based on internal business objectives, and/or as determined by its product marketing strategy. A complete interface for advertisers to submit bids and receive feedback may be provided. An advertisement servicing system may proportionately adjust the bids so that the total amount bid is capped by the available advertising space. The resulting distribution of advertising space makes it appear as if the advertisers collaboratively divided the total available space among themselves—the most efficient result for the company.

After the bids have been adjusted, each advertiser may be given the opportunity to approve its adjusted bid. An advertiser not satisfied with an adjustment may submit a revised bid. Each time a revised bid is submitted all the bids may be readjusted and sent to the advertisers for approval. The bidding process may terminate when no further bids are submitted. Failure to submit a revised bid within a predetermined time period may be deemed approval of an adjusted bid.

The final set of bids may be used to determine the allocation of advertising space on the website. The difference between an original bid and the adjusted bid may be refunded to the advertiser. Under this system, advertisers are charged only for the percentage of advertising space they have purchased, eliminating wasteful overbidding. If an adjustment resulted in a bid increase, any additional charges may be collected from the advertiser.

In some embodiments, the company may assign each advertiser units of bidding power (“tokens”) to spend on internal advertising. The company may assert its priorities through the number of tokens allocated to each advertiser. Sample factors that may be considered include product profitability, company goals, and the relative importance of the advertised product or message with respect to the overall company goals. In some embodiments tokens may be allocated automatically, based on one or more quantifiable factors such as the revenue generated by a line of business.

In some embodiments, a company may reward effective advertising by allocating additional tokens to a successful advertiser. Effectiveness may be measured by the click-through rate of the advertisement or some other appropriate method. In some embodiments, the click-through rate may be adjusted based on the relevance of the advertisement to the product or service it promotes.

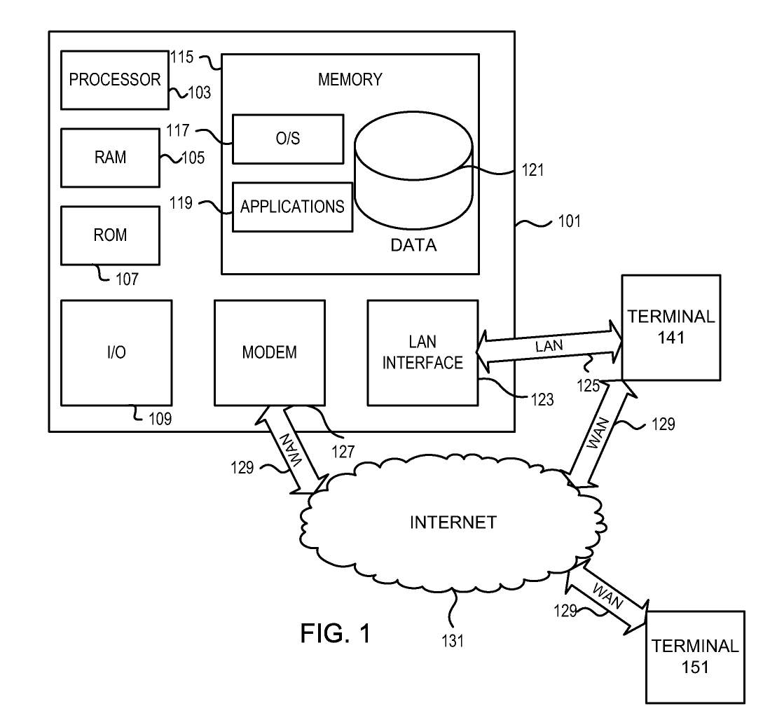

FIGS. 1-4 show illustrative embodiments and features of the invention.

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

As will be appreciated by one of skill in the art upon reading the following disclosure, various aspects described herein may be embodied as a method, a data processing system, or a computer program product. Accordingly, those aspects may take the form of an entirely hardware embodiment, an entirely software embodiment or an embodiment combining software and hardware aspects.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

FIG. 1 is a block diagram that illustrates a generic computing device 101 (alternatively referred to herein as a “server”) that may be used according to an illustrative embodiment of the invention. The computer server 101 may have a processor 103 for controlling overall operation of the server and its associated components, including RAM 105, ROM 107, input/output module 109, and memory 115.

Input/output (“I/O”) module 109 may include a microphone, keypad, touch screen, and/or stylus through which a user of device 101 may provide input, and may also include one or more of a speaker for providing audio output and a video display device for providing textual, audiovisual and/or graphical output. Software may be stored within memory 115 and/or storage to provide instructions to processor 103 for enabling server 101 to perform various functions. For example, memory 115 may store software used by server 101, such as an operating system 117, application programs 119, and an associated database 121. Alternatively, some or all of server 101 computer executable instructions may be embodied in hardware or firmware (not shown). As described in detail below, database 121 may provide storage for account information, account holder information, account application data and statistics, and any other suitable information.

Server 101 may operate in a networked environment supporting connections to one or more remote computers, such as terminals 141 and 151. Terminals 141 and 151 may be personal computers or servers that include many or all of the elements described above relative to server 101. The network connections depicted in FIG. 1 include a local area network (LAN) 125 and a wide area network (WAN) 129, but may also include other networks. When used in a LAN networking environment, computer 101 is connected to LAN 125 through a network interface or adapter 123. When used in a WAN networking environment, server 101 may include a modem 127 or other means for establishing communications over WAN 129, such as Internet 131. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 119, which may be used by server 101, may include computer executable instructions for invoking user functionality related to communication, such as email, short message service (SMS), and voice input and speech recognition applications.

Computing device 101 and/or terminals 141 or 151 may also be mobile terminals including various other components, such as a battery, speaker, and antennas (not shown).

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

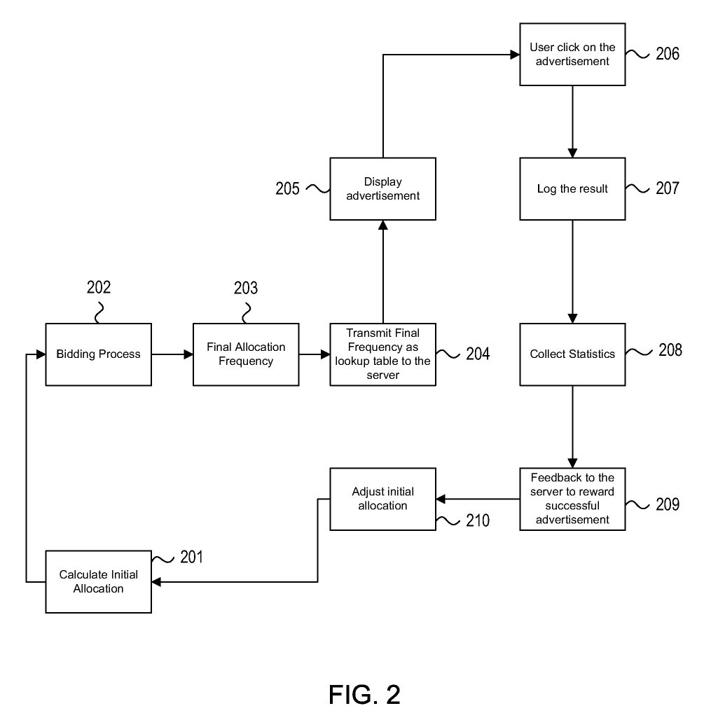

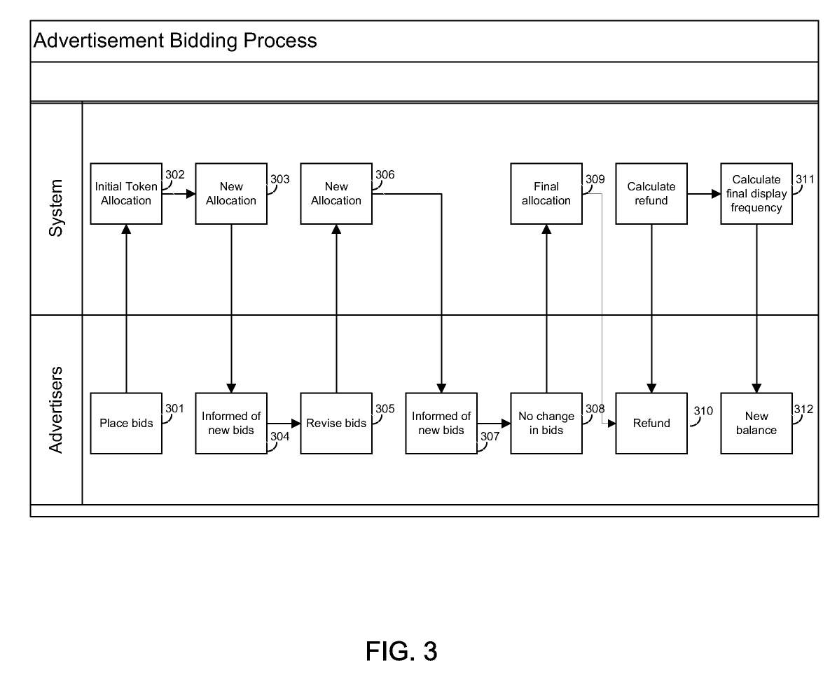

FIGS. 2-3 show illustrative processes. For the sake of illustration, the process will be described as being performed by a system. The system may include one or more of the devices shown in FIGS. 1, one or more individuals and/or any other suitable device or approach.

FIG. 2 shows illustrative process 200 for adjusting market-based bidding toward overall site optimization. After the initial allocation of tokens, advertisers may bid on internal advertising space. When the advertising display is operational, data may be collected regarding the effectiveness of each advertisement in the display. The bidding power of an advertiser may be raised based if its campaign proves successful. Process 200 has a circular flow, and may repeat each time the company markets its advertising space to the advertisers.

The steps of process 200 are now described in greater detail. At step 201, tokens may be allocated to any division of the company authorized to place web advertisements. At step 202, the advertisers may bid on company website space, including display frequency for a shared space. Bids may be adjusted based on the total space available. If the advertisers approve the adjusted bids, the bidding terminates and the process continues at step 203. If any advertiser chooses to revise its bid, the step 202 continues. The bids may be readjusted and sent to the advertisers for approval. The bidding may continue until all the advertisers approve the readjusted bids. When no more revised bids are submitted, the bidding process terminates and the adjustment becomes final. The process continues at step 203. At step 203, the display frequency is calculated based on the percentage paid by each advertiser. At step 204, the display frequency is submitted to the server which will control advertisement display on the website. At step 205, the advertisements are displayed according to the predetermined frequency. At step 206, website users may click on an advertisement, known as clicking through. Click-through by website users is a standard measure of advertising success. At step 207, click-through is logged by the system. At step 208, the statistics for all the advertisements are collected to analyze the effectiveness of the different advertising campaigns. Click-through may be one factor considered. At step 209, effective campaigns are singled out for reward. At step 210, the allocation of tokens is adjusted. These adjustments may reward effective advertising or may be motivated by some other company objective.

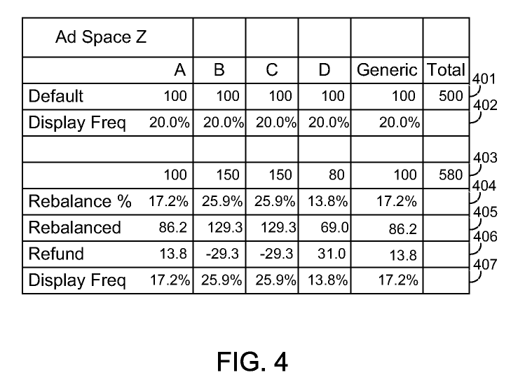

FIGS. 3-4 show illustrative processes 300 and 400, respectively. Each of processes 300 and 400 may correspond in whole or in part to one of the steps in process 200.

FIG. 3 shows illustrative process 300 for bidding on advertising space, focusing primarily on the interaction between the advertisers and the servicing system. FIG. 3 may correspond in whole or in part to one or more of steps 202-203 (shown in FIG. 2). Advertisers submit bids which are adjusted by the system, based on the total advertising space available. The system transmits the adjusted bids to the advertisers for approval and the advertisers may enter revised bids. After the final readjustment, any difference between an original bid and the adjusted bid is refunded to the advertiser.

The steps of process 300 are now described in greater detail. At step 301, advertisers enter their bids into the servicing system. A complete interface for advertisers to submit bids and receive feedback may be provided. At step 302, the system calculates a hypothetical allocation of advertising space based on the initial bids. At step 303, the system generates a new allocation based on the total amount of space actually available, and adjusts the bids accordingly. At step 304, the system transmits the adjusted bids to the advertisers for approval. At step 305, advertisers may revise and resubmit their bids. At step 306, the system readjusts the allocation of advertising space based on any revised bids. At step 307, the system transmits any readjusted bids the advertisers. The bidding process terminates at step 308, where all the advertisers approve the adjusted allocation of advertising space. At step 309, the adjusted allocation becomes the final allocation. At step 310, the system refunds any excess tokens to due to advertisers whose adjusted bids have decreased. At step 311, the system converts the allocation into a plan for display frequency on a website. At step 312, the advertisers have new balances to put toward other spending.

FIG. 4 shows illustrative example 400 which illustrates the bidding process with a hypothetical numerical example. FIG. 4 may correspond in whole or in part to one or more of steps 202-203 (shown in FIG. 2). Example 400 contemplates four advertisers (A, B, C and D) bidding for display frequency in a single advertising space (Space Z). A fifth slot in the rotating display is taken by generic company advertising.

Example 400 is now described in greater detail. Rows 401-402 illustrate the default allocation of advertising space, independent of market-based input by the advertisers. At row 401, the default cost of advertising space is shown. Each advertiser pays 100 tokens, filling 500 tokens worth of advertising space. At row 402, each advertiser has purchased an equal amount of Space Z and each of the five advertisements will be displayed 20% of the time.

Steps 403-407 illustrate the allocation of advertising space taking into account market-based advertiser input. At row 403, advertisers B and C are very interested in Space Z and increase their bids to 150 tokens. Advertiser D is less interested in Space Z and withdraws 20 tokens to spend elsewhere, reducing its bid to 80 tokens. The other two bids remain at the default level of 100 tokens. The total number of tokens bid is now 580. At row 404, each advertiser's bid is converted into a percentage of the total amount bid. At row 405 each advertiser's percentage is reapplied to the 500 tokens worth of actual available space to arrive at adjusted bids. At row 406, the adjusted bids generate a refund of tokens to advertisers A and D. At row 407, the display frequency for the advertisements in Space Z is calculated based on the adjusted bids.

Aspects of the invention have been described in terms of illustrative embodiments thereof. A person having ordinary skill in the art will appreciate that numerous additional embodiments, modifications, and variations may exist that remain within the scope and spirit of the invention.

One of ordinary skill in the art will appreciate that the apparatus features described herein and illustrated in the FIGS. may be arranged in other than the recited configuration and that one or more of the features may be optional. Also, the methods described herein and illustrated in the FIGS. may be performed in other than the recited order and that one or more steps illustrated may be optional. The above-referenced embodiments may involve the use of other additional elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, systems and methods for allocating internal advertising space have been provided. Persons skilled in the art will appreciate that the present invention can be practiced by other than the described embodiments, which are presented for purposes of illustration rather than of limitation, and that the present invention is limited only by the claims that follow.

What is claimed is:

1. A method for electronically adjusting market-based bids for web advertising space on an entity website, the method comprising:
receiving two or more electronic bids for internal advertising space on a website;
adjusting the bids based on the total available advertising space; and
generating an advertising display based on the adjusted bids.

2. The method of claim 1 wherein the bids are received from different divisions of the entity competing against each other for available advertising space.

3. The method of claim 2 wherein the divisions are lines of business of the entity.

4. The method of claim 1 wherein the available advertising space comprises advertising placement.

5. The method of claim 1 wherein the available advertising space comprises display frequency.

6. The method of claim 1 wherein the available advertising space comprises duration of an advertising display agreement.

7. The method of claim 1 further comprising obtaining advertiser approval for an adjusted bid.

8. The method claim 7 further comprising:
transmitting an adjusted bid to an advertiser for approval; and
receiving advertiser approval.

9. The method of claim 7 further comprising:
receiving a revised bid from an advertiser; and
readjusting one or more of the bids based on the total available advertising space.

10. The method of claim 7 further comprising terminating the bidding process if all the adjusted bids are approved.

11. The method of claim 1 further comprising allocating one or more units of bidding power to an advertiser to spend on internal advertising space.

12. The method of claim 11 further comprising allocating one or more additional units of bidding power to an advertiser with effective advertising.

13. The method of claim 12 wherein effectiveness is measured by click-through rate or adjusted click-through rate.

14. A computer-readable medium storing computer-executable instructions which, when executed by a processor on a computer system, perform a method for electronically allocating internal web advertising space, the method comprising:
receiving two or more bids for internal advertising space on a company website;
adjusting the bids by algorithm based on the total advertising space available; and
generating an advertising display based on the adjusted bids.

15. The medium of claim 14 wherein the method further comprises:
receiving a revised bid from an advertiser; and
readjusting one or more of the bids based on the total advertising space available.

16. The medium of claim 14 wherein the method further comprises transmitting an adjusted bid to an advertiser for approval.
